(19) United States
(12) Patent Application Publication
(10) Pub. No.: US 2026/0299884 A1
(43) Pub. Date: Oct. 1, 2026

(54) DOT PRODUCT REDUCTION TREE FOR SIGN-EXTENSION ENCODING

(71) Applicant: ADVANCED MICRO DEVICES, INC., Santa Clara, CA (US)

(72) Inventor: Eric Mark Schwarz, Fishkill, NY (US)

(21) Appl. No.: 19/407,836

(22) Filed: Dec. 3, 2025

Related U.S. Application Data
(60) Provisional application No. 63/752,261, filed on Jan. 31, 2025.

(51) Int. Cl. G06F 7/533

(52) U.S. Cl. CPC G06F 7/533

(57) ABSTRACT

Techniques are provided for computing dot products using a compression-based reduction architecture. A set of partial products is generated based on an encoded set of input values, such as multiple vector-scalar operand pairs, and are reduced in parallel with an additional addend value, such as an accumulated result from a prior operation. A compression tree reduces the partial products into intermediate results, which are combined with the addend and a constant value to generate a final dot product.

### BACKGROUND

As machine learning (ML) workloads evolve, there is growing demand for hardware-accelerated support of low-precision arithmetic operations. Integer formats such as 8-bit (INT8) are widely adopted in ML inference pipelines due to an associated favorable balance between computational efficiency and model accuracy. In particular, dot product operations involving INT8 operands and higher-precision accumulators have become a central computational primitive in many artificial intelligence (AI) applications.

At a hardware level, computing a dot product of INT8 operands entails generating multiple 16-bit partial products and accumulating them into a higher-precision result. This process involves structured reduction of the intermediate values using adder trees (circuitry embodying arithmetic logic and configured to perform multi-operand addition through a sequence of intermediate summations) or compressor trees (circuitry embodying an arrangement of logic elements and configured to reduce a plurality of input operands into a pair of outputs without performing full carry propagation at each intermediate stage), with additional logic to handle signed and unsigned operand combinations. Because INT8 operands can represent signed values, each partial product must be sign-extended (in which the bit-width of a signed binary value is increased by replicating its most significant bit into higher-order bits of the extended-width result) to ensure correct arithmetic when combining results of differing magnitudes.

Conventional approaches often require multiple stages of carry-propagating addition to complete the summation of these products and incorporate the prior accumulation value. This can introduce latency and increase the hardware area consumed (e.g., for adder and/or compression tree structures). Moreover, the need to fully resolve each product before accumulation may limit opportunities for deeper parallelism and its corresponding efficiencies.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system utilizing at least one CPU configured to execute instructions for one or more applications represented by instructions and other data stored in one or more system memories, in accordance with some embodiments.

FIG. 2 illustrates a dot product reduction tree for accumulating four vector-scalar products and a bias term in accordance with some embodiments.

FIG. 3 illustrates a compression tree for evaluating a dot product expression based on encoded partial products, in accordance with some embodiments.

FIG. 4 illustrates an operational routine for performing a dot product computation based on a set of encoded input values, a fixed constant, and a parallel accumulation value (addend), in accordance with various embodiments.

### DETAILED DESCRIPTION

As AI accelerators and general-purpose processors seek to increase throughput while minimizing power and area costs, there is a continued need to optimize low-precision arithmetic pipelines. This includes finding more efficient ways to handle the intermediate values produced by INT8 dot products and their associated sign-extension encodings during accumulation. Accordingly, improved techniques for reduction and accumulation in INT8 vector dot product operations remain an area of active development.

Instruction set extensions such as Vector Neural Network Instructions (VNNI) enable parallel computation of multiple INT8 dot products within a single instruction, often accumulating results into 32-bit integer registers. These instructions typically multiply corresponding operand elements—such as A0 through A3 with B0 through B3—and sum the resulting products together along with a prior accumulation value.

As used herein, Booth coding refers to a technique for utilizing multiplier operands in binary multiplication to reduce the number of partial products that must be generated and accumulated. By encoding groups of adjacent bits in the multiplier using signed-digit representations, Booth coding enables the hardware to eliminate redundant operations such as multiplying by zero or adding the same multiplicand multiple times in consecutive positions. In radix-4 Booth encoding, for example, pairs of bits from the multiplier are recoded to select between −2×, −1×, 0×, +1×, or +2×versions of the multiplicand, thereby halving the number of partial products compared to traditional shift-and-add methods. A Booth decoder generates control signals for each segment of the encoded multiplier based on overlapping bit windows. These signals are then used to control a Booth multiplexer, which selects and appropriately shifts and sign-extends the multiplicand to generate the required partial products. This approach is well-suited for hardware multiply-accumulate operations such as dot products, in which reducing the number of partial products directly lowers latency and power consumption in the subsequent reduction tree.

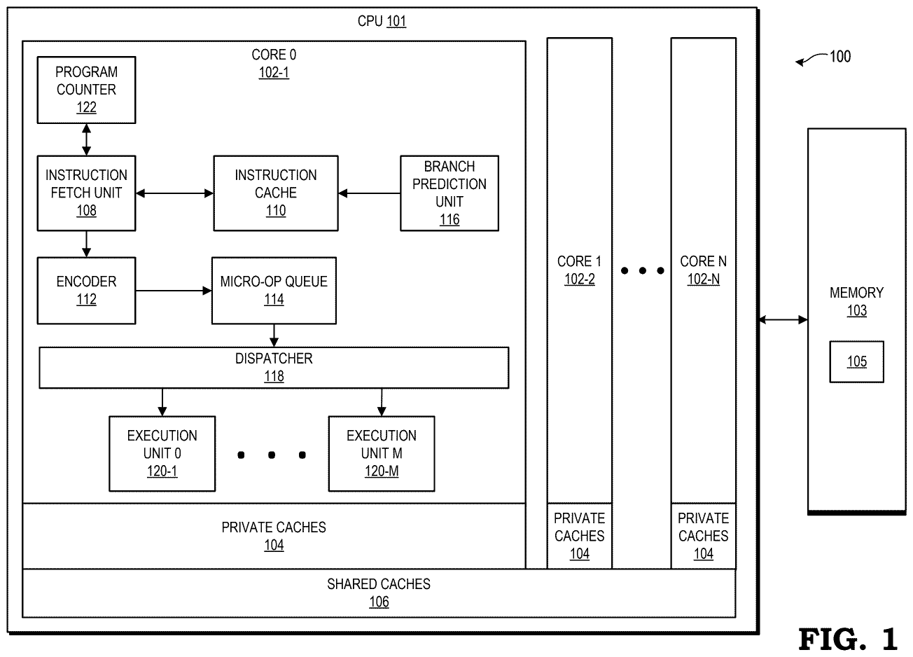

FIG. 1 presents a processing system 100 utilizing at least one CPU 101 configured to execute instructions for one or more applications represented by instructions and other data stored in one or more system memories 103 in accordance with some embodiments. To execute these applications, the CPU 101 includes an architecture having one or more processor cores 102 each associated with one or more private caches 104 and one or more shared caches 106, which in some embodiments store operand vectors or intermediate accumulation values used across multiple execution cycles or instruction streams. The private caches 104 each include one or both of a volatile memory or non-volatile memory, and are included in or otherwise connected (e.g., by a data fabric or bus) to and accessible by a respective processor core 102.

As an example, CPU 101 includes a respective first private cache (e.g., L0 cache), and a respective second private cache 104 (e.g., L1 cache) that are included in or otherwise connected a corresponding processor core 102 such that they are each only accessible by the corresponding processor core 102. Additionally, the shared caches 106 each include a volatile memory, non-volatile memory, or both and are each connected (e.g., by a data fabric or bus) to and accessible by two or more processor cores 102. For example, CPU 101 includes a last-level cache (e.g., L3 cache) connected to and accessible by two or more processor cores (e.g., core 0 102-1, core 1 102-2, core N 102-N). Each of the private caches 104 and shared caches 106 are configured to store instructions to be executed by CPU 101, data (e.g., operands, values) used in the execution of the instructions, data resulting from the execution of one or more instructions, or any combination thereof. According to some embodiments, for each processor core 102, the private caches 104, shared caches 106, and a system memory (e.g., random access memory (RAM)) accessible by the processor core 102 are arranged in a hierarchy based on the respective sizes of the caches and system memory.

CPU 101 is configured to execute instructions (e.g., instructions 105 stored in system memory 103) of one or more threads based on the type of architecture (e.g., an instruction set architecture (ISA)) associated with CPU 101. For example, based on CPU 101 having a complex instruction set computer (CISC) instruction set architecture (e.g., x86 architecture), CPU 101 is configured to execute instructions from a CISC instruction set (e.g., x86 instruction set). Additionally, based on CPU 101 having a reduced instruction set compute (RISC) instruction set architecture (e.g., ARM instruction set architecture, AVR instruction set architecture), CPU 101 is configured to execute instructions from a RISC instruction set (e.g., ARM instruction set, AVR instruction set). To execute instructions from an instruction set for one or more threads, CPU 101 includes one or more processor cores 104 each including a program counter 122, instruction fetch unit 108, instruction cache 110, decoder 112, micro-op queue 114, branch prediction unit 116, dispatcher 118, and one or more execution units 120. In various embodiments, the execution unit 120 includes scalar, vector, or specialized execution logic for performing operations such as integer multiplication, fused multiply-accumulate, or dot product computations involving tree-based reduction. In embodiments, each processor core 104 is configured to concurrently execute instructions for two or more threads. Though the example embodiment presented in FIG. 1 shows CPU 101 as including three processor cores (102-1, 102-2, 102-N) representing an N number of processor cores 102, in other embodiments, CPU 101 may include any number of processor cores 102 based on design choices.

The program counter 122 of a processor core 104 can include a register configured to sequentially store data (e.g., pointers) representing the memory addresses of instructions in one or more threads to be executed for an application. As an example, the program counter 122 stores data indicating the physical or virtual addresses of one or more instructions of a thread in the order in which the instructions are to be executed. Based on the memory addresses indicated in the program counter 122, the instruction fetch unit 108 of the processor core 102 fetches instructions from the instruction cache 110 to execute. This instruction cache 110, for example, includes at least a portion of a private cache 104 accessible by the processor core 102 arranged in a hierarchy with one or more other private caches 104, shared caches 106, and the system memory also accessible by the processor core 102. According to embodiments, the instruction fetch unit 108 first requests an instruction at the memory address indicated by the program counter 122 from the instruction cache 110. Based on the instruction not being in the instruction cache 110, a controller of the instruction cache 110 then request the instruction from the cache at a next level of the hierarchy. The controllers of the caches then continue requesting the instruction in this way until the instruction is found in a cache or the instruction is requested from the system memory, at which point the instruction is provided to the instruction fetch unit 108. In some embodiments, the processor core 102 is configured to prefetch one or more instructions to be performed for the thread into one or more caches, such as instruction cache 110.

After the instruction fetch unit 108 has retrieved the instruction indicated by the program counter 122, the instruction fetch unit 108 provides the instruction to decoder 112 and increments the program counter 122 so as to indicate the next instruction to be executed. As an example, after retrieving an instruction, instruction fetch unit 108 stores the instruction in an instruction register included in or otherwise connected to decoder 112. The decoder 112 includes circuitry configured to decode the instruction to determine the operation code (“op-code”) of the instruction, one or more operands associated with the instruction, or both. For example, from the instruction, the decoder 112 determines op-code (e.g., micro op-code) indicating a type of instruction (e.g., load instruction, store instruction, ADD instruction, subtract instruction, branch instruction, conditional branch instruction, shift instruction) and which execution unit 120 is to execute the instruction. After decoding the instruction, the decoder 112 stores data indicating the op-code and operands of the instruction in a micro-op queue 114. This micro-op queue 114 includes one or more queues configured to store the decoded op-code (e.g., micro op-code) of instructions before the decoded op-code is provided to the execution engine 120 indicated by the op-code. According to some embodiments, based on an instruction indicating a conditional branch instruction, branch prediction unit 116 is configured to predict one or more additional instructions. For example, from the conditional branch instruction, the branch prediction unit 116 determines a predicted branch (e.g., a branch predicted to be taken when the instruction is executed) and an unpredicted branch (e.g., a branch not predicted to be taken when the instruction is executed). Based on the predicted branch, branch prediction unit 116 then determines one or more additional instructions to be executed and, in embodiments, instructs instruction fetch unit 108 to retrieve these additional instructions.

The data indicating the op-code and operands associated with the instruction is provided from the micro-op queue 114 to a dispatcher 118 that includes circuitry configured to route the data to the corresponding execution engine 120 indicated in the op-code. An execution engine 120 of the processor core 102 includes circuitry configured to execute the op-code indicated in the data provided by dispatcher 118. For example, an execution engine 120 includes a floating-point unit, integer unit, or the like. Further, each execution engine 120 includes a renamer that includes circuitry configured to allocate one or more registers of the execution unit 120 to store the operands of the instructions. For example, the renamer translates architectural registers indicated by the op-code of the instruction to one or more physical registers of the execution unit 120. After renaming the registers associated with the instruction, scheduling circuitry (e.g., scheduling queues) of the execution engine 120 provides data representing operations to be performed for the instruction to one or more execution pipes. For example, based on the operands and type of instruction, the scheduling circuitry provides data representing the operations to be performed to corresponding execution pipes. Each of these execution pipes of an engine 120 includes circuitry configured to perform one or more respective operations indicated by the op-code associated with an instruction such as one or more arithmetic logic unit operations, address generation unit operations, floating point add operations, fused multiply-add operations, or the like. After an execution pipe has performed an operation for an instruction, the data resulting from the performance of the operation is stored in a private cache 104, shared cache 106, system memory 103, or any combination thereof accessible by the processor core 102.

As noted above, in embodiments the system 100 is configured to execute instructions configured in accordance with at least one ISA and/or ISA extension. Once such ISA is the aforementioned x86 ISA. The x86 ISA is a family of instruction sets primarily used by compute systems, such as processing system 100, utilizing central processing units (CPUs) (e.g., CPU 101) or similar processors from Intel Corp. and Advanced Micro Devices (AMD) Inc. The x86 ISA primarily is directed to CISC (Complex Instruction Set Computing), which means that its instruction set includes a large number of instructions, some of which are capable of performing multiple operations in a single instruction. In an x86 architecture, a processor uses a set of general-purpose registers to perform operations on data. These registers hold operands for operations and store intermediate results. The architecture also uses a stack for function calls and local variables, with the stack pointer keeping track of the top of the stack. PUSH and POP operations are used to manipulate the stack during program execution. An Instruction Pointer holds the address of the next instruction to be executed and is automatically updated as instructions are processed. Control flow instructions modify the value of the instruction pointer, allowing for conditional and unconditional jumps in the execution flow.

The x86 ISAs include a range of basic instruction types. Data movement instructions like MOV, PUSH, and POP are used to move data between registers, memory, and the stack. Arithmetic operations such as ADD, SUB, MUL, and DIV manipulate data in registers or memory. The architecture also supports control flow instructions, such as JMP (unconditional jump) and CALL (function call), as well as conditional jump instructions like JE (jump if equal) and JNE (jump if not equal), which rely on the processor's flags to determine whether to alter the flow of execution. Logical operations like AND, OR, XOR, and NOT are used to perform bitwise operations on data, while string operations like MOVSB (move string byte) and CMPSB (compare string byte) are designed to manipulate sequences of data. Additionally, system and interrupt instructions such as INT and IRET allow the processor to handle external events or internal errors by transferring control to interrupt service routines.

Over time, x86 processors have incorporated additional features, such as SIMD (Single Instruction, Multiple Data) and SIMT (Single Instruction, Multiple Threads), which are accessed, instruction-wise, via ISA extensions to accelerate parallel computing tasks. Once such set of x86 ISA extensions includes AVX (Advanced Vector Extensions), which is generally directed to improving the performance of computationally demanding applications by enabling more efficient SIMD or SIMT operations. AVX enhances the x86 instruction set by offering powerful vector operations that significantly boost performance in tasks such as scientific computing, video processing, machine learning, and cryptography, where parallel data processing is crucial. One of the primary features of AVX is its wide vector registers. AVX extends the width of vector registers to 256 bits, which allows each register to hold up to eight single-precision (32-bit) floating-point numbers or four double-precision (64-bit) floating-point numbers. This increased register width enables processors to handle more data per operation, improving overall throughput and making data processing much more efficient. Moreover, AVX is designed to leverage SIMD and/or SIMT parallelism, which means that a single instruction can perform the same operation on multiple data elements simultaneously. This parallelism is particularly beneficial for tasks like matrix multiplication or large-scale data processing, as one instruction can process multiple pieces of data at once, greatly speeding up computation. Another feature of AVX is its optimization for floating-point calculations. The instruction set supports efficient operations such as addition, multiplication, and dot products on vectorized data, which are common in applications that rely heavily on floating-point computation, including 3D rendering, scientific simulations, and signal processing. Additionally, some versions of AVX support Fused Multiply-Add (FMA) instructions, which allow a single instruction to multiply two numbers and then add the result to a third. This helps reduce the latency of calculations and improves precision, which is especially beneficial in areas like linear algebra and numerical simulations.

AVX also introduces new instructions that enhance performance, such as AVX-optimized arithmetic operations for floating-point vector calculations. Instructions like VADDPS and VMULPS perform vectorized addition and multiplication, respectively, while others, like VPERMILPS, allow for more complex operations like reordering elements in a vector. These new instructions enable processors to handle large datasets more efficiently with fewer clock cycles. Furthermore, AVX helps improve power efficiency by optimizing the use of processor pipelines, meaning that certain operations can be completed using less energy, which is critical for tasks requiring extensive computational power.

Currently, additional matrix-related features and a corresponding ISA extension is being developed to provide higher compute density capabilities and to provide for operations to accelerate matrix math operations. These one or more extensions, referred to collectively herein as Advanced Computation Extension (ACE), augments AVX and scalar code with unique capabilities, adding: ACE register state, including tile and block scale registers; data processing operations that consume AVX register input and operate on tile register state; data move operations to move data between ACE register state, AVX registers and memory; state and operations for system management. This ACE extension provides for integration between AVX vectors and ACE tile registers, combining high compute density tile processing operations with the comprehensive data processing features of AVX.

In some embodiments, ACE adds a tile register file, containing a number of two-dimensional tile registers, each being, for example, 512-bits wide by 16 rows, with each row equivalent in size to a single AVX-512 vector. Each tile register row has width of 512-bits and may be viewed as composed of a number of elements, dependent on the type of data being processed in the tile register. For example, support for 32-bit (FP32 or INT32) accumulator types may be provided, and thus each ACE tile register row is therefore equivalent to 16 32-bit elements. ACE also, in implementations, may provide a number of tile registers; the number implemented is architecture specific and discoverable in feature registers.

One set of AVX instructions is referred to as Vector Neural Network Instructions (VNN Instructions). These VNN instructions are configured to support neural network and machine learning programs and operations. For example, machine learning programs sometimes utilize “small” data formats such as 8-bit integers and the primary operation to be executed is a dot-product. The dot-product can be used to generate a weighted summation of many input values. The X86 architecture defines VNNI INT8 operations of 4-way dot-product where the result R is expressed as

R=A3 ×B3+A2×B2+A1×B1+A0×B0+C.

The terms A3, B3, A2, B2, A1, B1, A0, and B0 are all in INT8 format and selectably signed or unsigned. The term C is in 32-bit Integer format, such that if either A or B is signed then C is signed, and otherwise unsigned. The products of 8-bit integers are 16-bit integers. When calculating these dot products several partial products are added together and conventionally the products are reduced completely prior to being summed together due to sign extension encoding. Disclosed herein are techniques where the partial products are summed together with the addend without first producing the individual products.

To illustrate, 8-bit integer multiplication is typically accomplished by radix-4 Booth encoding the multiplier, and creating multiples of the multiplicand to produce five partial products. The partial product array is a banded diagonal matrix, and the sign extension of each partial product is encoded into this band with two bits for every partial product except the least significant which uses three bits. The two bit encode is (1, S′) where S′ is the inverted sign bit of the partial product. And the three bit encode of the least significant partial product is (S′, S, S) where S′ is the inverted sign bit of the partial product and S is the true sign bit. This sign-extension encoding when added, causes a carry out of the 16-bit product which is ignored. If these partial products are reduced with the addend prior to summing completely it is not known whether the sign-extension carry out has occurred or not and in some cases this causes bits in the addend to be perturbed incorrectly. In addition, the 16-bit products need to be sign-extended prior to adding to a 32-bit integer addend.

Conventionally, a processor adds each product first and ignores the carry out, and then sums the products. Next, the processor sign extends the sum of products and adds the sign-extended sum to the addend. This implementation is relatively slow. Conventionally, partial products are summed using a limited carry propagation using 3:2 or 4:2 counters which are very fast. Accordingly, whenever a full product is produced there needs to be a 2:1 adder that propagates the carry from the least significant bit to the most significant bit. Thus, under the conventional approach there is a 2:1 adder on each product, another on the sum of products and a third for adding the sum of products to the addend. In some cases, one of these three adders is removed and the partial products are added in parallel to first get the sum of products. Thus, some processors employ 3 or 2 carry-propagate 2:1 adders.

Disclosed herein are techniques for dealing with the carry-outs of each product and extending the sign-extension to the addend's 32-bit width in parallel, without using 2:1 adders prior to the final adder. By reducing the partial products in parallel with the addend and adding a constant to the summation, the carry-outs are propagated completely out of the summation. For example, the constant used for 4×16-bit products is 33′h1FFF80000. When this constant is added in parallel with the 4×5 partial products with sign extension encoding and the 32-bit addend, the reduction occurs with limited carry propagation to the final 2:1 adder.

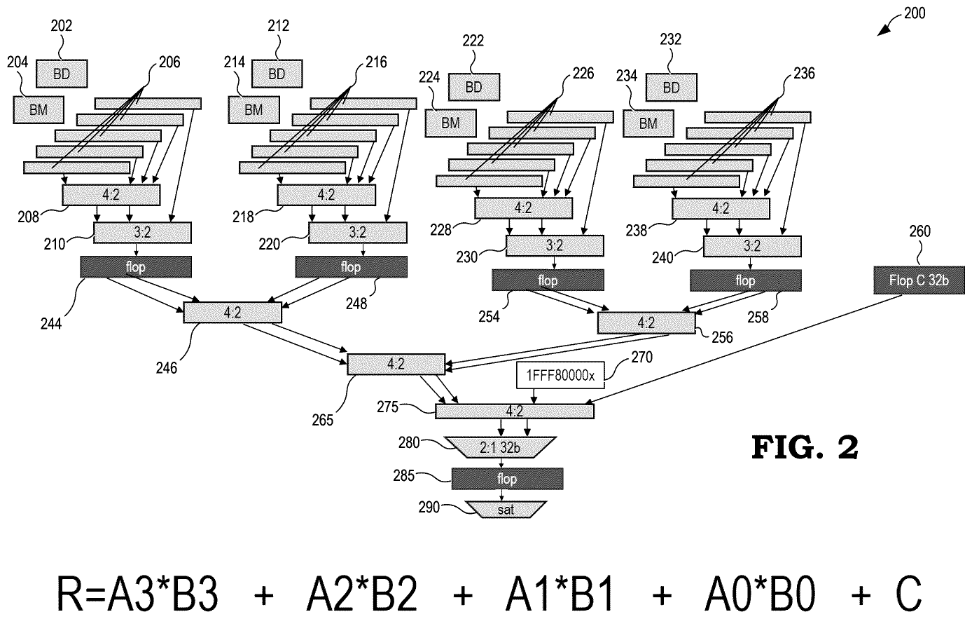

FIG. 2 illustrates a dot product reduction tree 200 for accumulating four vector-scalar products and a bias term in accordance with some embodiments. As used herein, a reduction tree refers to a structured network of circuitry embodying arithmetic or logic elements, such that the structured network is configured to progressively combine multiple input values into a reduced set of outputs (e.g., for summing partial products or aggregating intermediate results). In various embodiments, a reduction tree may include compressor circuits, such as 3:2 or 4:2 counters or other multi-operand compressors, as well as adder stages, arranged to exploit parallelism and minimize carry propagation delays. As used herein, a multi-operand compressor refers to a combinational logic circuit configured to receive multiple binary input values and generate a reduced set of output values representing a logically equivalent sum, typically expressed in terms of separate sum and carry components. A multi-operand compressor may be used to reduce partial products in arithmetic datapaths, such as those generated during multiplication or dot product computation. Examples of multi-operand compressors include compressor circuits that combine three or more operands into two or fewer outputs, such as 3:2 compressors, 4:2 compressors, or generalized carry-save compressors. Such compressor circuits enable efficient parallel reduction of multiple binary inputs while avoiding full carry propagation at each stage.

In some embodiments, a reduction tree may perform carry-save accumulation across multiple levels, followed by a final carry-propagate adder to produce a fully resolved result. Reduction trees are commonly employed in multiply-accumulate units and other arithmetic datapaths to enhance throughput and area efficiency in processing multiple operand terms.

As depicted, the dot product reduction tree 200 corresponds to an evaluation of the expression

R=A3×B3+A2×B2+A1×B1+A0×B0+C

in which A0 through A3 represent vector elements, B0 through B3 represent corresponding scalar values, and C represents an initial bias or accumulation value. Each vector-scalar product A×B is reduced via Booth encoding and compressed through a staged tree of 3:2 and 4:2 compressors, as further described below.

To generate partial products for each of the four vector-scalar products, a first set of Booth decoders 202, 212, 222, and 232 receives Booth-encoded control bits from each respective scalar operand B0 through B3. Each Booth decoder 202, 212, 222, 232 respectively produces control signals to drive a corresponding Booth multiplexer 204, 214, 224, and 234. Each Booth multiplexer 204, 214, 224, 234 selects, shifts, and sign-extends segments of the associated vector operand A0 through A3 to produce a set of partial products 206, 216, 226, and 236 based on the respective vector and scalar inputs. In some embodiments, the set of input values comprises one or more pairs of vector elements and corresponding scalar operands, each contributing to a partial product group via Booth-encoded selection. In the depicted example, each partial product 206, 216, 226, 236 comprises five 16-bit partial products, though other partial product widths or quantities may be used in other configurations.

Each set of partial products 206, 216, 226, 236 is first reduced via a pair of compressor stages—a 4:2 compressor followed by a 3:2 compressor—shown as elements 208 and 210 for partial products 206; 218 and 220 for partial products 216; 228 and 230 for partial products 226; and 238 and 240 for partial products 236. Each 3:2 compressor stage 210, 220, 230, 240 produces sum and carry outputs that are then registered in a respective pipeline stage (e.g., respective flop elements 244, 248, 254, 258).

The outputs from each pipeline stage—flops 244, 248, 254, and 258—are forwarded into a shared reduction structure that merges the intermediate products across the different dot product terms. The intermediate partial product values registered in flops 244, 248, 254, and 258 are then reduced together with the addend value held in flop 260, such that the reduction tree processes the partial products and the addend in parallel. In some embodiments, the addend may correspond to a pre-existing accumulation value or bias term to be included in the dot product result.

In the depicted embodiment, the outputs of flop 244 and flop 248 are combined using a 4:2 compressor 246; the outputs of flop 254 and flop 258 are combined using a 4:2 compressor 256; and the outputs of those 4:2 compressors 246, 256 are then combined via a second 4:2 compressor 265. In this manner, the compressor 265 therefore receives a total of four inputs: two outputs from 4:2 compressor 246 and two outputs from 4:2 compressor 256. These represent the compressed intermediate results of the earlier dot product stages.

The outputs of compressor 265 are combined with a fixed value 270 and the bias term C (32 bits in the depicted embodiment, provided via flop 260) using another 4:2 compressor 275. This compressor 275 thus merges four inputs—two output values from compressor 265, the addend held in flop 260, and a fixed constant value 270—to produce a final pair of carry-save outputs, which are passed to a 2:1 carry-propagate adder 280. In this manner, the depicted digital logic components contribute to a fully accumulated dot product output, formed by combining the reduced set of partial products, the addend, and the constant.

The carry-propagate adder 280 resolves the accumulated result into a single 32-bit value. The result is stored in a pipeline register (flop) 285 and optionally processed by saturation logic 290 to constrain the output to a valid representable range. As used herein, saturation logic refers to circuitry configured to constrain a computed value within a predefined numerical range, such that values exceeding an upper bound are clamped to that maximum, and values falling below a lower bound are clamped to that minimum. In various embodiments, such saturation logic may be used to prevent overflow or underflow in fixed-point or integer arithmetic operations, and is commonly applied following accumulation or multiplication operations to ensure that the final result remains representable within a target bit width or numeric format.

As described above, the reduction tree structure 200 allows high-throughput accumulation of Booth-encoded vector-scalar products and a bias value with low-latency propagation through the arithmetic datapath. In some embodiments, sign extension and alignment for the partial products 206, 216, 226, 236 may be handled upstream of the reduction tree structure 200, and the tree itself may be implemented using carry-save arithmetic until the final 2:1 adder stage 280. Thus, in various embodiments, the arrangement of compressor stages and flop boundaries may be varied to accommodate specific timing, power, or area constraints.

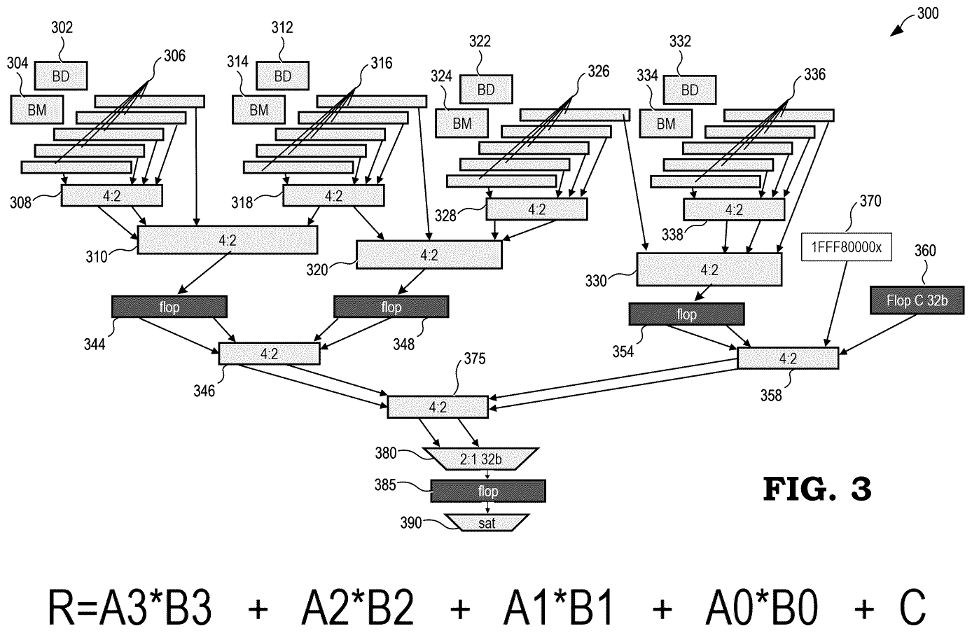

FIG. 3 illustrates a compression tree 300 for evaluating a dot product expression based on encoded partial products, in accordance with some embodiments. As used herein, a compression tree refers to a hierarchical arrangement of circuitry embodying arithmetic or logic elements, such that the hierarchical arrangement is configured to reduce a plurality of input operands into a pair of outputs—typically a sum and a carry—without performing full carry propagation at each intermediate stage. In various embodiments, a compression tree may include multiple levels of multi-operand compressor circuits such as 3:2 or 4:2 counters, each of which locally aggregates several input bits into fewer output bits. By delaying carry propagation until a final stage, compression trees allow for more efficient parallel accumulation of partial products in arithmetic operations such as multiplication or dot product computations. In some implementations, compression trees may be integrated with adder trees or selectively substituted for portions of such trees to optimize area and timing characteristics.

In a manner similar to that described above with respect to FIG. 2, the compression tree 300 is configured to implement and perform a computation of the form:

R=A3×B3+A2×B2+A1×B1+A0×B0+C

in which A0 through A3 are vector operands, B0 through B3 are scalar operands, and C is a 32-bit bias or accumulation value. The compression tree 300 operates on the same underlying partial product sets as reduction tree 200 of FIG. 2, but reorganizes their aggregation and pipelining to flatten the hierarchy and eliminate intermediate 3:2 compressors. As such, the compression tree 300 reduces the number of carry-propagate stages, potentially improving timing and area efficiency.

For each dot product term Ai×Bi, a Booth decoder 302, 312, 322, or 332 receives Booth-encoded control bits from the corresponding scalar operand Bi. Each Booth decoder generates select and control signals for a corresponding Booth multiplexer 304, 314, 324, or 334, which selects, shifts, and sign-extends segments of the respective vector operand Ai to produce a set of partial products. In the depicted non-limiting example, each output 306, 316, 326, and 336 represents a group of five 16-bit partial products (such as consistent with radix-4 Booth encoding of 8-bit operands).

Each partial product group 306, 316, 326, and 336 is reduced using a dedicated 4:2 compressor stage—namely, 4:2 compressors 308, 318, 328, and 338, respectively. The outputs of these initial compressors are then provided to a second stage of 4:2 compressors: compressor 310 receives outputs from 308 and 318; compressor 320 receives outputs from 318 and 328; and compressor 330 receives outputs from 328 and 338. This tiered structure provides overlap across inputs, promoting denser reduction without relying on interleaved 3:2 compressor stages as used in FIG. 2.

The outputs of second-stage compressors 310, 320, and 330 are then respectively registered in pipeline flops 344, 348, and 354, which provide timing isolation before convergence of the intermediate values. In parallel, the 32-bit bias term C is latched in a separate pipeline flop 360. Outputs from flops 344 and 348 are fed to a 4:2 compressor 346, while outputs from flop 354 and bias flop 360 are provided to another 4:2 compressor 358. In this manner, each of compressors 346 and 358 produces two output vectors—typically representing carry and sum paths—which are then merged by a subsequent 4:2 compressor 375.

The outputs of compressor 375 are further reduced by a 2:1 compressor 380, which performs a final carry-propagate addition to generate a fully resolved result. The output of the 2:1 compressor 380 is then latched in flop 385 and provided to a saturation logic block 390. While in the depicted embodiment the adder 380 produces a 32-bit result, in various embodiments the adder 380 may support a narrower or greater bit-width—for example, when configured as a 33-bit adder, allowing either greater value ranges or to capture a carry out value. In certain embodiments, the saturation logic 390 applies range clamping or other limiting behavior based on the data format in use (e.g., INT8, INT16), as discussed elsewhere herein.

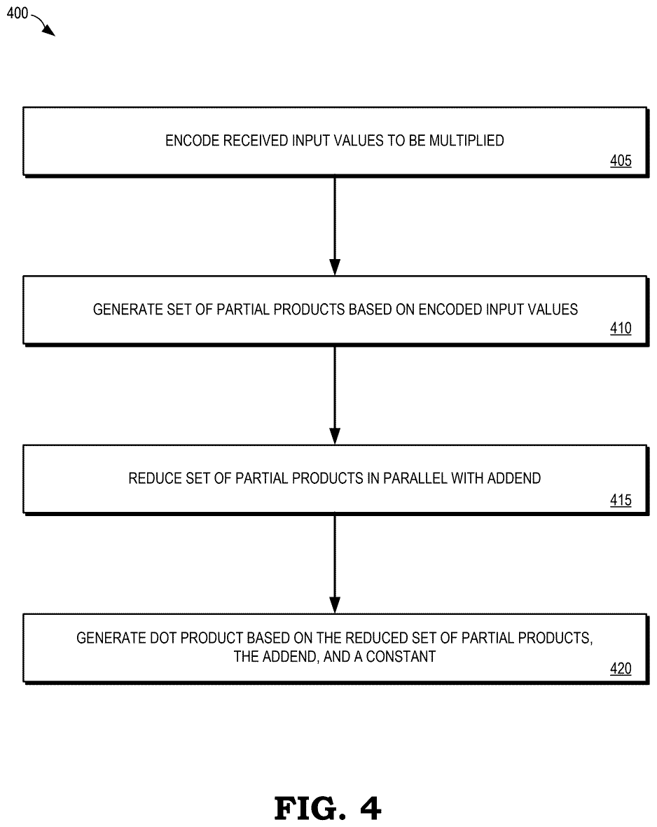

FIG. 4 illustrates an operational routine 400 for performing a dot product computation based on a set of encoded input values, a fixed constant, and a parallel accumulation value (addend), in accordance with various embodiments. The routine may be performed, for example, by a processing system (e.g., processing system 100, with reference to FIG. 1) that includes one or more processors (e.g., CPU 101).

The routine 400 begins at block 405, where a set of received input values to be multiplied is encoded. In some embodiments, this encoding may include sign extension and Booth encoding of signed integer operands, with each operand pair comprising a scalar and a vector element. The encoded values are organized into a form suitable for parallel multiplication and partial product generation. The routine proceeds to block 410.

At block 410, a set of partial products is generated based on the encoded input values. Each partial product may represent a scaled contribution from an input pair, aligned and formatted to facilitate subsequent reduction. In some embodiments and scenarios, the partial products include a uniform bit width and aligned positions based on operand selection and/or shift logic. The routine proceeds to block 415.

At block 415, the routine reduces the set of partial products in parallel with an addend. In certain embodiments, such reduction is performed using a multi-level compression tree comprising one or more multi-operand compressors, such as 3:2 or 4:2 compressors. The addend may be supplied from an earlier accumulation stage and introduced into the reduction path in parallel with the partial products. In some embodiments and scenarios, intermediate results produced during this stage are registered between compressor levels to preserve timing and pipeline alignment. The routine proceeds to block 420.

At block 420, a dot product is generated based on the reduced set of partial products, the addend, and a constant. The constant may represent a fixed bias value, and may be applied in the same stage or in a subsequent addition path. The result of the dot product computation may be clamped or saturated to a predetermined numerical range based on the target output format, which may include fixed-point or integer representations.

In some embodiments, the apparatus and techniques described above are implemented in a system including one or more integrated circuit (IC) devices (also referred to as integrated circuit packages or microchips), such as the processing system 100 described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry”, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A computer-implemented method comprising:
generating a set of partial products based on a set of input values;
generating a reduced set of partial products by reducing the set of partial products in parallel with an addend; and
generating a dot product as output based on the reduced set of partial products, the addend, and a constant.

2. The method of claim 1, wherein generating the set of partial products comprises Booth encoding each input value.

3. The method of claim 1, wherein each input value comprises a pair of vector and scalar operands.

4. The method of claim 1, wherein reducing the set of partial products comprises using a compression tree having one or more multi-operand compressors to reduce the set of partial products into intermediate results.

5. The method of claim 4, wherein the compression tree comprises an additional multi-operand compressor configured to perform one or more operations based on the intermediate results.

6. The method of claim 1, wherein the addend is received from a prior accumulation stage and is provided to reduction logic for reducing the set of partial products in parallel with the set of partial products.

7. The method of claim 1, wherein the constant is a fixed bias value applied as an additional operand.

8. The method of claim 7, wherein the dot product is generated from four pairs of 16-bit operands, and wherein the fixed bias value is 33′h1FFF80000.

9. The method of claim 1, further comprising storing intermediate outputs of generating the reduced set of partial products in one or more registers prior to generating the dot product.

10. The method of claim 1, wherein the set of partial products includes a plurality of aligned terms having a uniform bit width.

11. The method of claim 1, wherein reducing the set of partial products and the addend comprises combining outputs from multiple compressor stages.

12. The method of claim 1, wherein generating the dot product further comprises clamping a final accumulated value to a predetermined range.

13. The method of claim 1, wherein generating the dot product comprises generating the dot product in fixed-point arithmetic format using sign-extended integer inputs.

14. A processing system comprising:
encoding circuitry to encode a set of input values for multiplication;
partial product generator circuitry that is coupled to the encoding circuitry and configured to generate a set of partial products based on the encoded input values;
reduction logic circuitry coupled to the partial product generator and configured to reduce the set of partial products in parallel with an addend; and
dot product logic circuitry coupled to the reduction logic circuitry and configured to generate a dot product based on the reduced set of partial products, the addend, and a constant.

15. The processing system of claim 14, wherein the encoding circuitry comprises a Booth encoder to perform Booth encoding on each input value.

16. The processing system of claim 14, wherein the reduction logic circuitry comprises a compression tree having one or more multi-operand compressors to reduce the set of partial products into intermediate results.

17. The processing system of claim 16, wherein the compression tree further comprises an additional multi-operand compressor configured to perform one or more operations based on the intermediate results.

18. The processing system of claim 14, wherein the constant comprises a fixed bias value applied as an additional operand during generation of the dot product.

19. The processing system of claim 14, wherein the reduction logic circuitry is configured to combine outputs from multiple compressor stages during reduction of the set of partial products and the addend.

20. A non-transitory computer readable medium storing executable instructions that, when executed by at least one processor, manipulate the at least one processor to:
generate a set of partial products based on a set of input values;
reduce the set of partial products in parallel with an addend; and
generate a dot product as output based on the reduced set of partial products, the addend, and a constant.
